(19) United States
(12) Patent Application Publication
(10) Pub. No.: US 2005/0253801 A1
(43) Pub. Date: Nov. 17, 2005

(54) Photo-write-type image display method and image display device

(75) Inventor: Hideo Kobayashi, Kanagawa (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 11/016,888

(22) Filed: Dec. 21, 2004

(30) Foreign Application Priority Data
May 11, 2004 (JP) P2004-141654

(51) Int. Cl. G09G 3/38

(52) U.S. Cl. 345/105

(57) ABSTRACT

A photo-write-type image display method photo-writes into an image display medium comprising a polarity display element and an optical switching element. The method includes applying a first polarity pulse to the image display medium to write a first display color into the image display medium, and applying a second polarity pulse to the image display medium while exposing the optical switching element to light, to write a second display color to the image display medium. In the applying of the second polarity pulse, voltage is applied to the polarity display element so that the first display color displayed in a non-exposure region of the image display medium is maintained after the applying of the second polarity pulse.

### BACKGROUND OF THE INVENTION

1. Field of the Invention

The present invention relates to a photo-write-type image display method and an image display device including a polarity display element and an optical switching element, and more particularly to a photo-write-type image display method and an image display device which enable high-quality image display of high contrast and high visibility.

2. Description of the Related Art

In recent years, a photo-write-type image display device employing a combination of a photoconductive switching element and a display element has been developed and put into practical use as a light valve in a projector and the like, and in addition, its potential for the field of optical information processing has been studied. While a predetermined voltage is applied to an image display medium, the photo-write-type image display device changes impedance of the photo-conductive switching element according to an amount of light received, thereby controlling the voltage applied to the display element to drive the display element so as to display an image thereon. In particular, a medium—in which a display element exhibiting a memory characteristic and a photoconductive switching element are laminated, and on which optical image is incident while voltage being applied thereto, thereby writing the image—is unsusceptible to effects of a dirty write head, can be rewritten a number of times, and can be carried separately from a write device. Therefore, the medium has attracted attention as an electronic paper medium.

As a display element for use in such a photo-write-type image display device, a display element using of a liquid crystal display element, such as cholesteric liquid crystal or ferroelectric liquid crystal, has been known (see JP-A-2000-180888).

According to the image display device disclosed in JP-A-2000-180888, display can be effectively turned on even in a display element, such as cholesteric liquid crystal, which requires a sharp voltage drop to turn on the display at a time of voltage off.

Meanwhile, as display elements other than a liquid crystal display element, non-liquid crystal type elements, such as an electrophoretic element, an electric field rotation element, a toner electric field transfer type element, a particle transfer type element, and an electrochromic element, have attracted attention as elements of high contrast and higher visibility. The state of driving of the elements is usually determined by a direction where an electric field is applied; or is determined depending on whether electric current flows from a display-side electrode to the opposite side thereof, as is the case with an electrochromic element, or to the display-side electrode from the opposite side. Hereinafter, an element whose display state is selected depending on a direction of an electric field or current is defined as a “polarity display element.” In contrast, an element, such as a liquid crystal element, whose display state is controlled by an electric field being applied thereto and is not dependent on the direction where the electric field is applied is defined as a “non-polarity display element.”

As a photo-write-type image display device making use of such a polarity display element and optical switching element, a photo-write-type image display device which employs an electrochromic element as the polarity display element has been known (see JP-A-2000-292818).

According to image display device disclosed in JP-A-2000-292818, when voltage or current is applied between electrodes, to thus radiate writing light, only a region where the writing light is radiated can be changed by means of oxidation-reduction. Since a plurality of electrochromic display bodies which emit different colors are laminated, when coloration-and-decoloration reaction is induced at specific portions on display faces of the respective layers in accordance with image data, a full-color display—which is brighter than a photo-write display device of a single-layer structure or that having color filters disposed therein—can be realized.

### SUMMARY OF THE INVENTION

However, the above described photo-write-type image display device employing a polarity display element and an optical switching element has a problem in that highly reliable display of a high-quality image is difficult. More specifically, in spite of characteristics of a polarity display element of high contrast and high visibility, the conventional photo-write-type image display device displays images of low contrast and poor visibility.

For instance, in a case of the image display device making use of an electrochromic element disclosed in Patent Document 2, first, as initialization, voltage is applied in the reverse direction, to thus render the display state uniform over the entire face. Subsequently, a voltage is applied, and an optical image enters. Accordingly, only desired portions are inverted to form an image. A region where light is radiated attains a desired display state; however, in a non-irradiated region, an electric field is applied in the reverse direction of the desired display state. When an electrochromic element is written by use of reduction potential, since reduction potential is applied to the non-exposure region even including a region where oxidation state is desired, an image easily deteriorates. When charge injection is induced in an electrochromic element by means of application of inverted potential, the state of the electrochromic element is changed.

Accordingly, the present invention aims at providing an image display method and an image display device, which enable a photo-write-type image display device employing a polarity display element and an optical switching element to display a high-quality image with high contrast and high visibility.

In order to achieve the object, according to one embodiment of the invention, a photo-write-type image display method photo-writes into an image display medium comprising a polarity display element and an optical switching element. The method includes applying a first polarity pulse to the image display medium to write a first display color into the image display medium, and applying a second polarity pulse to the image display medium while exposing the optical switching element to light, to write a second display color to the image display medium. In the applying of the second polarity pulse, voltage is applied to the polarity display element so that the first display color displayed in a non-exposure region of the image display medium is maintained after the applying of the second polarity pulse.

Here, the maintenance of the first display color after the applying of the second polarity pulse includes a case where the first display color does not change substantially and a case where the first display color returns to its original color even if changed. Here, occurrence of no substantial change in the first display color means a change rate of 10% or less, preferably a change rate of 5% or less, and more preferably a change rate of 3% or less.

In one embodiment of the invention, the polarity display element has an insensitive region. In the applying of the second polarity pulse, voltage of the second polarity pulse and an amount of the exposed light are adjusted so that an effective value of voltage applied to an area of the polarity display element corresponding to an exposure region is equal to or greater than a threshold value of the polarity display element having the insensitive region and that an effective value of voltage applied to another area of the polarity display element corresponding to the non-exposure region is equal to or less than the threshold value.

In another embodiment of the invention, in the applying of the second polarity pulse, voltage of second polarity pulse and an amount of the exposed light are adjusted so that voltage applied to an area of the polarity display element corresponding to the non-exposure region is undershot when application of the voltage is turned off.

In yet another embodiment of the invention, the method further includes appending to the image display medium. The appending generates an append start signal by bringing a light generation device that generates light irradiated onto the optical switching element into contact with an appending device provided on a surface of the image display medium, and appends by using the light generation device while a third polarity pulse is applied to the image display medium based on the append start signal.

In order to achieve the object, according to one embodiment of the invention, a photo-write-type image display device includes an image display medium, a voltage application device, a writing device, and a control device. The image display medium includes a polarity display element having an insensitive region, an optical switching element, a pair of electrodes at least one of which has a light transmission characteristic, and a pair of substrates at least one of which located on the same side as the electrode having the light transmission characteristic has a light transmission characteristic. The voltage application device applies a first polarity pulse and a second polarity pulse as voltages to the image display medium. The writing device applies the voltage by the voltage application device while radiates image information onto the optical switching element by means of light irradiation. The control device controls the voltage application device and the writing device. The control device performs a control operation after application of the first polarity pulse and at a time of application of the second polarity pulse so that an effective value of voltage applied to an area of the polarity display element corresponding to an exposure region of the optical switching element is equal to or greater than a threshold value of the polarity display element having the insensitive region and that an effective value of voltage applied to an area of the polarity display element corresponding to a non-exposure region of the optical switching element is equal to or less than the threshold value.

In order to achieve the object, according to one embodiment of the invention, a photo-write-type image display device includes an image display medium, a voltage application device, a writing device, and a control device. The image display medium includes a polarity display element having an insensitive region, an optical switching element, a pair of electrodes at least one of which has a light transmission characteristic, and a pair of substrates at least one of which located on the same side as the electrode having the light transmission characteristic has a light transmission characteristic. The voltage application device applies a first polarity pulse and a second polarity pulse as voltages to the image display medium. The writing device applies the voltage by the voltage application device while radiates image information onto the optical switching element by means of light irradiation. The control device controls the voltage application device and the writing device. The control device performs control operation so that voltage applied to an area of the polarity display element corresponding to a non-exposure region of the optical switching element is undershot when application of the second polarity pulse application is turned off, to perform impedance-matching control operation with respect to the polarity display element and the optical switching element after application of the first polarity pulse and at a time of application of the second polarity pulse.

According to the image display method and the image display device set forth above, a photo-write-type image display device including a polarity display element and an optical switching element can realize high-quality image display of high contrast and high visibility.

### BRIEF DESCRIPTION OF THE DRAWINGS

FIG. 1 is a view showing a schematic configuration of an image display device according to a first embodiment;

FIG. 2A is a view showing the entire configuration of the image display medium according to the first embodiment;

FIG. 2B is a view showing characteristics of a polarity display element having an insensitive region;

FIG. 3 is a view showing a circuit equivalent to the polarity display element having the insensitive region and an optical switching element according to the first embodiment;

FIGS. 4A to 4E are conceptual renderings showing example voltage waveforms applied to the polarity display element during exposure and during non-exposure according to the first embodiment;

FIG. 5 is a view showing a schematic configuration of an image display device according to a second embodiment;

FIG. 6 is a view showing the entire configuration of an image display medium according to the second embodiment;

FIG. 7 is a view showing a circuit equivalent to a polarity display element and an optical switching element of the second embodiment;

FIGS. 8A to 8E are conceptual renderings showing example voltage waveforms applied to the polarity display element during exposure and non-exposure according to the second embodiment;

FIG. 9 is a simplified view of an image display medium portion of the image display device according to a third embodiment of the present invention;

FIG. 10 is a view showing that the image display medium of Example 1 is connected in series with an optical switching medium;

FIG. 11 is a view showing a schematic configuration of an image display medium according to Example 2;

FIG. 12 is a view showing that an image display medium of Example 3 is connected in series with the optical switching medium;

FIG. 13 is a view showing a schematic configuration of an image display medium of Example 4;

FIG. 14 is a view showing a schematic configuration of an image display medium of Example 5;

FIGS. 15A and 15B are views showing response waveforms which are results of evaluation of Example 1; and

FIGS. 16A and 16B are view showing response waveforms which are results of evaluation of Example 3.

### DETAILED DESCRIPTION OF THE PREFERRED EMBODIMENT

### First Embodiment

(General Configuration of Image Display Device)

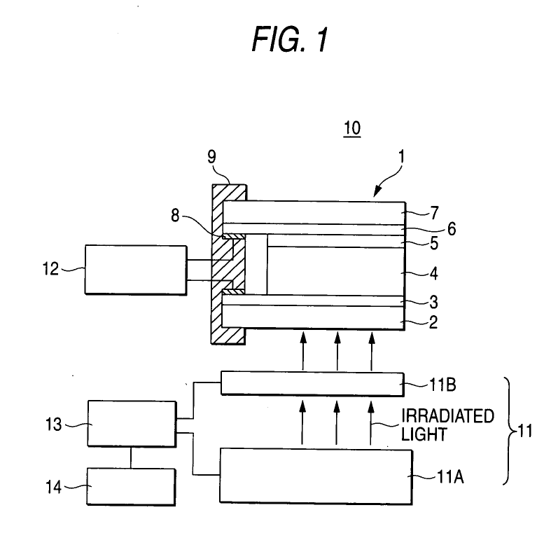

FIG. 1 shows an image display device according to a first embodiment of the present invention. The image display device 10 principally includes an image display medium 1, a feeding terminal 8, a connector 9, a writing unit 11, a voltage application device 12, and a control device 13. The image display medium 1 mainly has a transparent substrate 2, a transparent electrode 3, an optical switching element 4, a polarity display element 5 having an insensitive region, another transparent electrode 6, and a display-side substrate 7. The feeding terminal 8 is connected to the transparent electrodes 3, 6 of the image display medium 1. The connector 9 detachably connects the image display medium 1 to the write device. The writing unit 11 displays image information and effecting photo-writing by means of light-radiation. The voltage application device 12 applies drive voltage for effecting writing to the transparent electrodes 3, 6 via the feeding terminal 8. The control device 13 controls the writing unit 11 and the voltage application device 12 on the basis of image data stored in an image storage device 14. The write device referred to here indicates elements of the image display device 10 other than the image display medium 1.

(Configurations of Individual Sections of Image Display Device)

The connector 9 includes the feeding terminal 8 to be connected to the transparent electrodes 3, 6 of the image display medium 1, respectively. Accordingly, the image display medium 1 is configured so as to be attached to and detached from the write device. As is apparent, the image display medium 1 may be configured so as to be non-detachable.

The writing unit 11 is a unit for radiating light for use in writing onto the optical switching element 4 of the image display medium 1. The writing unit 11 includes a light generation unit serving as a light source, and a pattern formation unit for forming a pattern of radiated light. Examples of the light generation unit include a fluorescent light, a halogen lamp, an electro luminescence (EL) light, and the like. In addition, an arbitrary light-radiation unit is applicable, so long as it is a unit capable of radiating light onto the optical switching element 4. As the pattern formation unit, there may be used, for instance, a display of light-transmission type, such as a TFT liquid crystal display or a simple matrix-type liquid crystal display. In addition, a light-emission type display, such as an EL display or a CRT provided with both the light generation unit and the pattern formation unit, or a field emission display (FED) may also be used. Other means is applicable, so long as it is a unit capable of controlling the amount, wavelength, and irradiation pattern of light to be radiated.

The voltage application device 12 applies a drive pulse to effect display in synchronization with photo-write by means of the writing unit 11. The voltage application device 12 includes a pulse generation unit for generating an applied pulse, and a unit for detecting a trigger input for outputting the applied pulse voltage. As the pulse generation unit, for instance, there may be used a unit which has a waveform storage unit, such as a ROM, a D/A conversion unit, and a control unit, and which subjects a waveform read from the ROM at the time of voltage application into D/A conversion, thereby applying to the image display medium 1. Alternatively, there may be used a unit for generating a pulse by means of an electric circuit-like method, such as a pulse generation circuit rather than by means of the ROM. Any means other than the above is applicable, so long as it is means for applying a drive pulse, and no particular limitation is imposed thereon.

The control device 13 includes a unit for converting into display data image data transmitted from the image storage device 14 or other devices, and a unit for controlling operations of the writing unit 11 and the voltage application device 12.

The image storage device 14 has a storage unit for storing image data desired to be displayed on the image display medium 1 and is capable of capturing image data from data an output/input device connected to the image storage device 14. These devices 11 through 14 may be either integrated or separated.

(General Configuration of Image Display Medium)

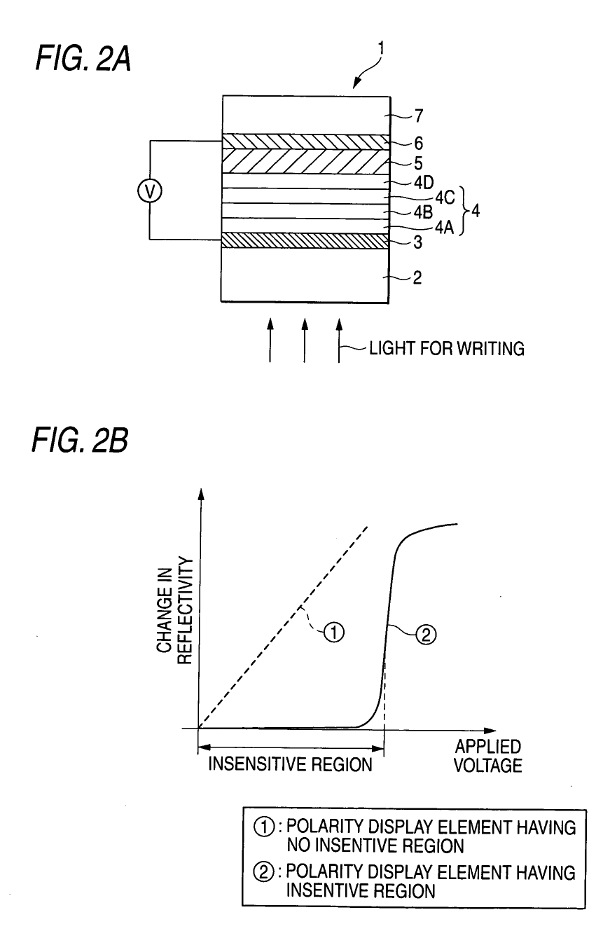

FIG. 2A shows the general configuration of the image display medium 1. The image display medium 1 includes the light-entrance-side transparent substrate 2, the transparent electrode 3, the optical switching element 4, the polarity display element 5 having the insensitive region, the transparent electrode 6, and the display-side substrate 7.

As shown in FIG. 2A, the image display medium 1 may have a configuration of transparent substrate/transparent electrode/polarity display element having an insensitive region/optical switching element/transparent electrode/transparent substrate. Alternatively, there may also be employed a configuration where writing-light and reading are effected on a single side; for instance, a configuration of transparent substrate/transparent electrode/polarity display element having an insensitive region/optical switching element/electrode/substrate; and an isolation layer, reflection layer, light absorption layer, or the like may be formed as required.

(Configurations of Individual Sections of Image Display Medium)

The light-entrance-side transparent substrate 2 is made of a light-transmitting material which allows radiation of light onto the optical switching element 4. More specifically, the transparent substrate 2 may be made of glass, polyethylene terephthalate (PET), polycarbonate (PC), polyethylene, polystyrene, polyimide, polyether sulfone (PES), or the like. It is preferable to use PET from the viewpoint of flexible, easy to form, and low-cost. When light is radiated from a direction of the display-side substrate 7, the light-entrance-side transparent substrate 2 is not limited to a light-transmitting material.

The transparent electrode 3 is made of a light-transmitting material so as to allow radiation of light onto the optical switching element 4. More specifically, the transparent electrode 3 may be made of an indium tin oxide (ITO) layer, Au, SnO₂, Al, Cu, or the like, is used. Preferably, the ITO layer is used. When light is radiated from a direction of the display-side substrate 7, the transparent electrode 3 is not limited to a light-transmitting material.

An essential requirement for the optical switching element 4 is to be capable of controlling voltage or current in accordance with the amount of received light. As an organic optical switching element there may be used, for instance, an amorphous silicon element; an OPC element of a separated-function-type two-layer structure making use of an organic photo-conductor; and an OPC element of a structure in which charge generation layers (CGL) are formed on the upper and lower sides of a charge transport layer (CTL) (hereinafter referred to as “dual CGL structure”). In particular, since an OPC element does not require heat treatment under high temperature, the OPC element is advantageous in that it can be applied to a flexible substrate such as a PET film. Furthermore, since the OPC element does not require a vacuum process, the OPC element is advantageous in that it can be manufactured at low cost. Among the above, the OPC elements of the dual CGL structure can be driven by AC voltage. Accordingly, image-burn phenomenon caused by transfer of ions due to bias components contained in the applied voltage occurs less frequently. Therefore, the dual CGL structure is a particularly effective structure. A carrier used for driving may be either positive or negative.

As shown in FIG. 2A, the optical switching element 4 of the dual CGL structure basically includes a lower charge generation layer 4A, a charge transport layer 4B, and an upper charge generation layer 4C.

An organic material which generates charges upon light irradiation can be used as a material for the charge generation layers 4A, 4C. Examples of such a material include metal phthalocyanine; metal-free phthalocyanine; a squarylium compound; an azlenium compound; perylene pigment; indigo pigment; azo pigments such as bis-azo pigments and tri-sazo pigments; quinacridone pigment; diketo-pyrrolopyrrole dye; polycyclic quinone pigment; condensed ring aromatic pigment such as dibromoanthanthrone; cyanine dye; xanthene pigment; a charge transfer complex such as polyvinyl carbazole and nitrofluorene; and a eutectic complex constituted of a pyrilium salt dye and a polycarbonate resin. However, particularly preferred is a charge generation material whose main component is any one of chlorogallium phthalocyanine, hydroxygallium phthalocyanine, and titanylophthalocyanine—which are phthalocyanines charge generation materials—or a combination thereof.

The upper charge generation layer 4A and the lower charge generation layer 4B, which must generate carriers and free electrons in the same quantity, are required to have almost the same sensitivity in terms of wavelength, quantity of light, and voltage. Accordingly, the upper and lower layers are desirably made of the same material. However, they may be made of different materials, so long as the materials have substantially equal sensitivity.

As the manufacturing method for the charge generating layers 4A, 4C, there may be employed a spin coating method making use of a solution or dispersion, a dip method, or the like, in addition to dry film formation methods, such as a vacuum deposition method, a sputtering method, and the like. None of these methods requires heating of a substrate or severe process control required for preparation of amorphous silicon or photodiode. Film thicknesses of the upper and lower charge generation layers 4A, 4C are 10 nm to 1 μm, preferably 20 nm to 500 nm. When the film thickness is less than 10 nm, the charge generation layer lacks photosensitivity, and preparation of uniform film becomes difficult. In contrast, when the film thickness is greater than 1 μm, photosensitivity is saturated and the layer tends to exfoliate due to stress within the layer.

Examples of a material used for the charge transport layer 4B include trinitrofluorenes; polyvinylcarbazoles; oxadiazoles; hydrazones such as benzylamino-based hydrazone, or quinoline-based hydrazone; stilbenes; diamines; triphenylamines; triphenylmethanes; benzidines; quinones; tetracyanoquinodimethane; furfleones; xanthones; and benzophenones. In addition, an ion conductive material, such as polyvinylalcohol or polyethylene oxide, both having LiClO₄ added thereto, is also applicable. Among the above, diamines are preferably used, in view of sensitivity and carrier transport capability.

As the manufacturing method for the charge transport layer 4B, there may be used a spin coating method making use of a solution or dispersion, a dip method, or the like, in addition to dry film formation methods, such as a vacuum deposition method, a sputtering method, and the like. Film thickness of the charge transport layer is 0.1 μm to 100 μm, preferably 1 μm to 10 μm. When the film thickness is less than 0.1 μm, voltage resistance of the charge transport layer is deteriorated, whereby assurance of reliability becomes difficult. On the contrary, when the film thickness is greater than 100 μm, impedance matching with functional elements becomes severe, and design becomes difficult. Accordingly, the above range is desirable.

An optical switching structure may be of a monolayer structure in which a charge generation material is contained in a charge transport layer between electrodes; a two-layer structure consisting of charge transport layer/charge generation layer; or a three-layer structure consisting of charge generation layer/charge transport layer/charge generation layer. Alternatively, a structure consisting of charge generation layer/charge transport layer/charge generation layer/charge transport layer/charge generation layer, which is configured by means of fabricating a charge generation layer between the charge transport layers, is also applicable.

In addition, a functional layer can be added to the above structure. For instance, a layer for preventing rushing of carriers can be formed between the electrode and the charge generation layer. Such a functional layer is applicable s long as flow of electric current is not obstructed.

The polarity display element 5 having the insensitive region is a display element having a memory characteristic, and is a polarity display element having an insensitive region. “Having an insensitive region” referred to here means that, as shown in FIG. 2B, the display element has a region of applied voltage where, under application of a predetermined voltage, display state does not changed depending on a time during which the voltage is applied. Accordingly, a reflection ratio does not change in the region. When a voltage exceeding the insensitive region is applied, a change of state occurs, whereby the reflection ratio changes. A value of an electric field at the boundary constitutes a threshold value. From a microscopic view, the entire element does not have a single threshold value. Some change, approximately 10%, is observed prior and subsequent to the threshold voltage.

The polarity display element 5 is an element whose display state is selected depending on a direction of an electric field or current. However, herein, an element driven by an electric field; that is, an element whose display state changes depending on an applied electric field, is employed. Examples of such an element include an electrophoretic element, an electric field migration element, an electric field rotation element, an electronic particulate material, and the like; and the electric field migration element or the electric field rotation element is preferably used. An electrochromic element, which is classified as a polarity display element, is a display element whose reflection ratio change depends on oxidation-reduction reaction, and is a current-driven-type element whose degree of change depends on the amount of current. Since the reflection ratio or a transmission ratio changes in accordance with the amount of current, the electrochromic element has no insensitive region.

The transparent electrode 6 is similar to the transparent electrode 3; however, an ITO layer, which is transparent, is preferably used so as not to obstruct display. In the case of a configuration in which a display screen is viewed from a direction of the light-entrance-side transparent substrate 2, the transparent electrode 3 is not limited to a transparent material.

The display-side substrate 7 is similar to the light-entrance-side transparent electrode 2; however, a glass substrate or a PET substrate, which is transparent so as not to obstruct display, is preferably used. When a configuration in which a display screen is viewed from a direction of the light-entrance-side transparent substrate 2 is employed, the display-side substrate 7 is not limited to a transparent material.

(Operation of Image Display Device)

Next, operations of the image display device 10 according to the first embodiment will be described.

Writing of an image is effected by means of an optical image corresponding to image information desired to be displayed is incident onto the image display medium 1, in conjunction with application of a write-drive voltage to the image display medium 1. Since the polarity display element 5 of the first embodiment of the invention has the memory characteristic, the image is retained even after application of the voltage is stopped. Meanwhile, the image display device 10 has a mechanism for setting and driving radiation intensity or radiation time of the respective optical image, or applied voltage and duty of the respective polarity pulse in accordance with applied positive/negative polarity pulses. However, the image display device 10 may include a mechanism for further adjusting the same. The adjustment mechanism may be either a mechanism which is adjustable by a user or a mechanism that is automatically adjusted upon detection of image quality.

As an image display method, there may be employed, for instance, a method where the entire screen is initialized into a single color by use of a first optical image in conjunction with application of a pulse; thereafter, a second image is input in conjunction with application of a pulse of reverse polarity. The first polarity may be either positive or negative. The “positive-polarity pulse” referred to here means that a positive voltage of, for instance, 10 V with reference to a ground (hereinafter, referred to as “GND”) is applied. In contrast, the “negative-polarity pulse” referred to here means that a negative voltage of −10 V with reference to the GND is applied. The GND may be, in this case, either the light-entrance-side transparent electrode 3 or the display-side transparent electrode 6. When the light-entrance-side and the display-side are identical, the GND may be either on the light-entrance-side or on the display-side.

A pulse must include at least a pair of positive-and-negative polarity pulses; however, in addition, a positive-polarity pulse and a negative-polarity pulse may be added thereto as a sub-pulse so as to obtain desired characteristics. Alternatively, positive-and-negative polarity pulses may be applied a plurality of times. Further alternatively, a period during which no voltage is applied may be inserted between the positive-polarity pulse and the negative-polarity pulse. Further alternatively, a single, a plurality of, or a combination of pulses of the reversed polarity or homo-polarity may be applied prior to the first pulse.

Effective voltage values of the first pulse and the second pulses may be substantially the same; however, that of the first pulse is preferably greater than that of the second pulse. The reason for this is as follows. An important condition for the first pulse is that the first pulse be displayed in a light-exposure region without fail. In contrast, since an unselected region, that is, a non-exposure region is displayed by means of the second pulse, the display state under application of the first pulse has little relation with a final quality of the display. Therefore, for obtaining sufficient image quality within the selected region; that is, within the exposure region, rendering the effective voltage of the first pulse greater than that of the second pulse is more effective.

The image display device 10 of the first embodiment of the invention employs a method such that, upon application of the second polarity pulse, applied is a voltage whose effective value in the exposure region is higher than or equal to the threshold value; and lower than or equal to the threshold value in the non-exposure region. More specifically, the above method is effected by means of controlling impedance of the polarity display element 5 and the optical switching element 4.

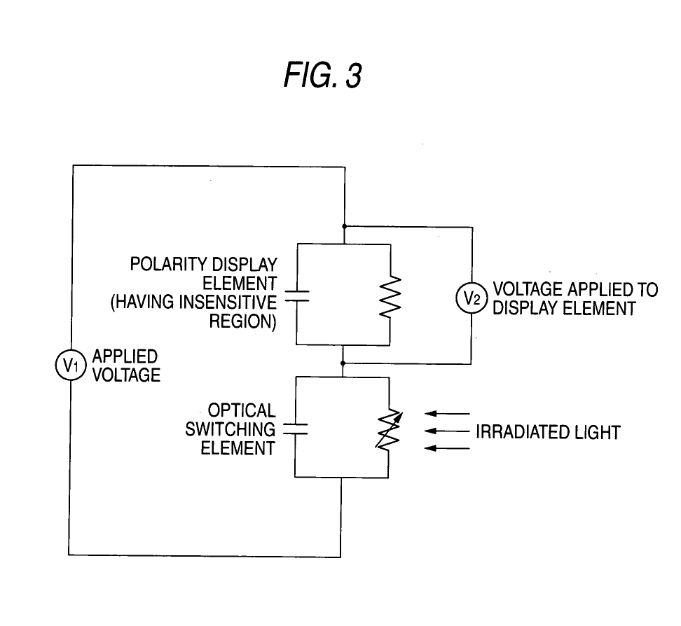

FIG. 3 shows an equivalent circuit of the polarity display element 5 having the insensitive region and the optical switching element 4 according to the first embodiment. Each of the optical switching element 4 and the display element 5 can generally be expressed as a parallel circuit consisting of a resistance component and a capacitance component. In the first embodiment of the invention, a product of the resistance component and the capacitance component is employed as a time constant.

“Effecting control of impedance of the polarity display element 5 and the optical switching element 4” means adopting the optical switching element 4 and the polarity display element 5 which are configured as follows. When the polarity display element 5 and the optical switching element 4 under irradiation, and the optical switching element 4 under non-irradiation are assumed to be capacitance and resistance arranged in parallel in an electric equivalent circuit, in terms of the time constant—which is a product of the capacitance and resistance of the respective elements—the relation “the optical switching element 4>polarity display element 5” holds under irradiation; and the relation “optical switching element 4<polarity display element 5” holds under non-irradiation. Parameters contributing to the time constant include a light-shield layer, a functional layer, or the like, in addition to the optical switching layer and the display layer. These layers may be considered to be included in the optical switching layer. The “irradiation” or “non-irradiation” referred to here is determined depending on sensitivity of the optical switching element, and the essential requirement is that irradiation>non-irradiation in terms of the amount of light. However, the amount of light during irradiation is preferably greater than or equal to about 100 μW/cm², and less or equal to about 20 μW/cm² during non-irradiation.

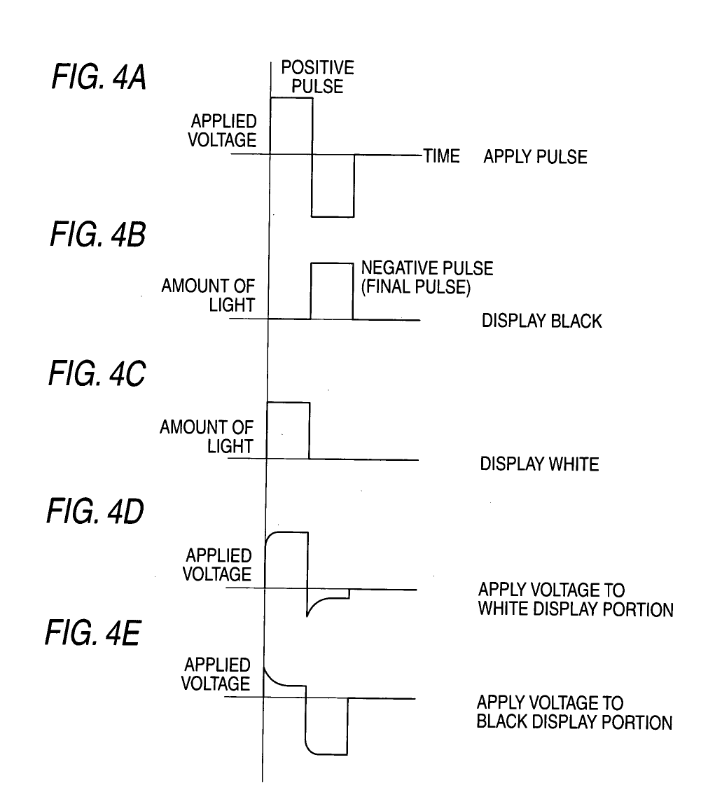

FIG. 4 is a conceptual view showing examples of voltage waveforms applied to polarity display elements during irradiation and non-irradiation according to the first embodiment. The optical switching element 4 is irradiated in conjunction with application of a first positive pulse, and subsequently a region on the optical switching element 4 where black is desired to be displayed is irradiated in conjunction with application of a second negative pulse (i.e., a final pulse). At this time, the voltage applied to the non-exposure region (a region which is desired to remain white) during application of the second negative pulse (final pulse) is a voltage within an insensitive region, and no change in the state is caused.

### Second Embodiment

(General Configuration of Image Display Device)

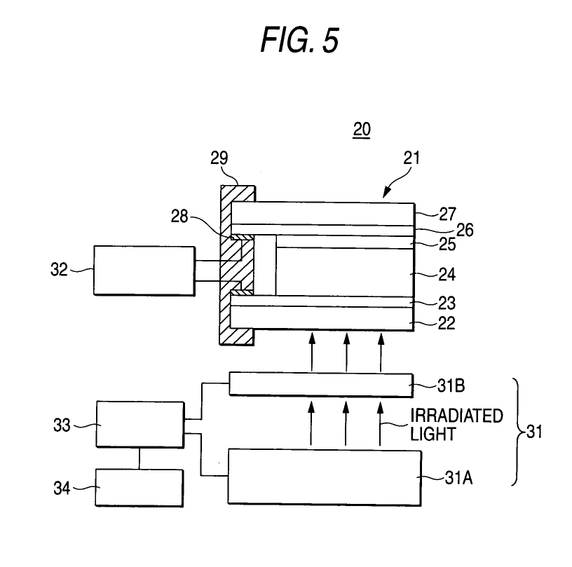

FIG. 5 shows an image display device according to a second embodiment of the present invention. The image display device 20 generally includes an image display medium 21; a feeding terminal 28 connected to transparent electrodes 23, 26 of the image display medium 21; a connector 29 for detachably connecting the image display medium 21 to a write device; a writing unit 31 for effecting photo-writing by means of performing display of image data and light-radiation; a voltage application device 32 for applying drive voltage for effecting writing to the transparent electrodes 23, 26 via the feeding terminal 28; and a control device 33 for controlling the writing unit 31 and the voltage application device 32 on the basis of image data stored in image storage device 34. The image display medium 21 mainly has a transparent substrate 22, the transparent electrode 23, an optical switching element 24, a polarity display element 25, the other transparent electrode 26, and a display-side substrate 27.

(Configurations of Individual Sections of Image Display Device)

The image display device 20 of the second embodiment is identical with that of the first embodiment in terms of basic configuration, except that the polarity display element 25 included in the image display medium 21 is not limited to a polarity display element having an insensitive region, and that a control method by the control device 33 differs from that of the first embodiment. Accordingly, repeated descriptions are omitted.

The control device 13 according to the first embodiment performs control such that, after application of the first polarity pulse, an effective value of the voltage applied to a region of the polarity display element 5 corresponding to a light-exposure region of the optical switching element 4 is greater than or equal to the threshold value of the polarity display elements; and the effective value of the voltage applied to a region of the polarity display element 5 corresponding to a non-exposure region of the optical switching element 4 is smaller than or equal to the threshold value of the polarity display element 5. In contrast, the control device 33 performs control such that, after application of the first polarity pulse, the voltage applied to a region of the polarity display element 25 corresponding to a non-exposure region of the optical switching element 24 undershoots at the time application of the second polarity pulse is turned off, thereby effecting impedance matching control of the polarity display element 25 and the optical switching element 24.

(General Configuration of Image Display Medium)

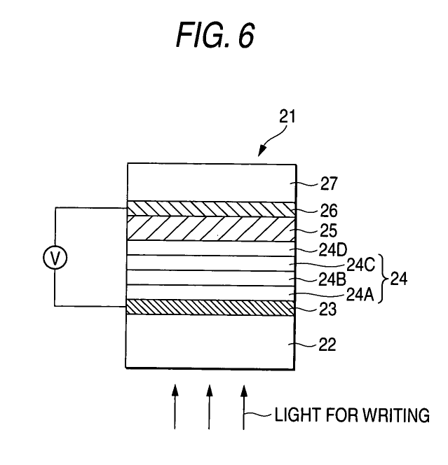

FIG. 6 shows the general configuration of the image display medium 21. The image display medium 21 has the light-entrance-side transparent substrate 22, the transparent electrode 23, the optical switching element 24, the polarity display element 25, the transparent electrode 26, and the display-side substrate 27. The image display medium 21 is identical with that of the first embodiment in terms of configuration, except for the polarity display element 25, and repeated descriptions are omitted.

An arbitrary polarity display element may be employed as the polarity display element 25, so long as it is an element, which exhibits a memory characteristic and can control display state depending on a direction of applied voltage or current. For instance, an electric field transfer particle element, an electric field rotation element, an electrophoretic element, an electrochromic element, an electronic particulate material transfer element, or the like may be employed. In the second embodiment, display is performed with use of electrolyte by means of depositing or dissolving Ag on a display-side electrode, depending on the applied polarity. Alternatively, there may be employed an electrochromic element or the like in which display is performed through oxidation-reduction of tungstic oxide, diphthalocyanine, or the like, fabricated on a display-side electrode by means of changing the polarity applied to the electrode.

(Operation of Image Display Device)

Next, operation of the image display device 20 according to the second embodiment will be described.

The image display device 20 adopts a method which performs display by means of impedance matching control in which the polarity display element 25 and the optical switching element 24 are controlled such that response waveform of voltage applied to the display element undershoots at the time of pulse-off after application of the second polarity pulse and during non-irradiation.

In the method, a voltage of reversed polarity is temporarily applied to the non-exposure region during application of the second polarity pulse. However, because of undershoot of the pulse, voltage is eventually applied in a desired electric field direction. As the result, display is free from deterioration caused by application of voltage in the reverse direction. For this reason, a polarity display element not having an insensitive region (i.e., not having a threshold characteristic), for instance, an electrochromic element or the like, can also be employed.

The impedance matching control referred to here means control in which a response waveform of a voltage applied to the display element upon application of a pulse is controlled by means of controlling respective impedances of the polarity display element 25 and the optical switching element 24. However, the impedance of the polarity display element 25 usually cannot be controlled actively. Therefore, the impedance matching is performed through control of the impedance of the optical switching element 24. Meanwhile, in addition to the impedances of the polarity display element and the optical element, there are impedances of other functional layers, parasitic impedance, or the like; however, such impedances may be equivalently included in the impedance of the optical switching element.

If the resistance and the time constant of the optical switching element 24 are greater than those of the polarity display element 25, the impedance control, which can be employed to undershoot the response waveform, becomes more effective.

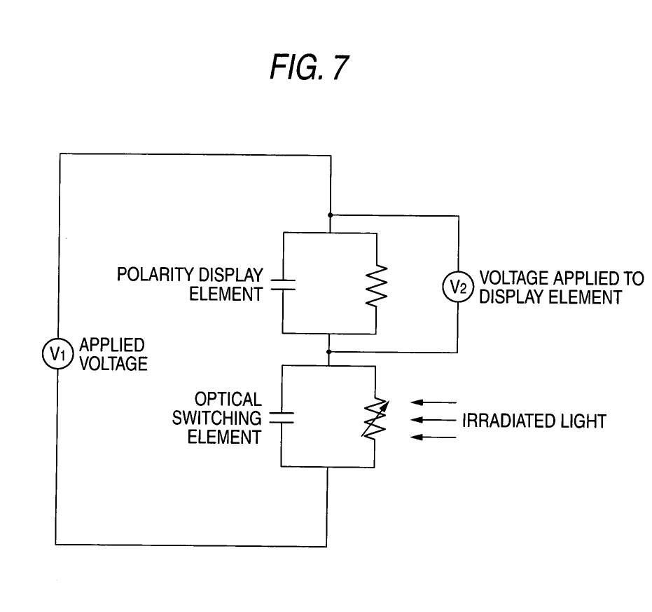

FIG. 7 shows an equivalent circuit of the polarity display element 25 and the optical switching element 24 of the second embodiment. Each of an optical switching element and a display element can usually be expressed as a parallel circuit including a resistance component and a capacitance component. In the invention, a product of the resistance component and the capacitance component is employed as a time constant.

“Rendering the resistance and the time constant of the optical switching element 24 greater than those of the polarity display element 25 during non-irradiation” referred to here means rendering the respective resistance components and time constants as follows: “the polarity display element 25<the optical switching element 24” in terms of the resistance component; and “the time constant of the optical switching element 24 is greater than or equal to five times that of the polarity display element 25, preferably greater than or equal to 10 times the same, further preferably greater than or equal to 100 times the same.” When the time constant is 10 times or greater, the power of undershoot is considerably high; and when the time constant is 100 times or greater, further higher undershoot can be obtained. A positive-and-negative rectangular wave can be employed as a waveform of a pulse applied to the image display medium 21. When the difference between the time constants is large, a response waveform with respect to the applied pulse approximates a differential waveform. Accordingly, the difference between the positive and negative effective power becomes small. Consequently, even when reversed polarity is applied, influence on the image quality is small. In addition, when the undershoot exceeds the threshold value, effects similar to those attained in the case where a desired polarity is applied can be obtained even when the polarity is reversed during pulse application, which is further preferable.

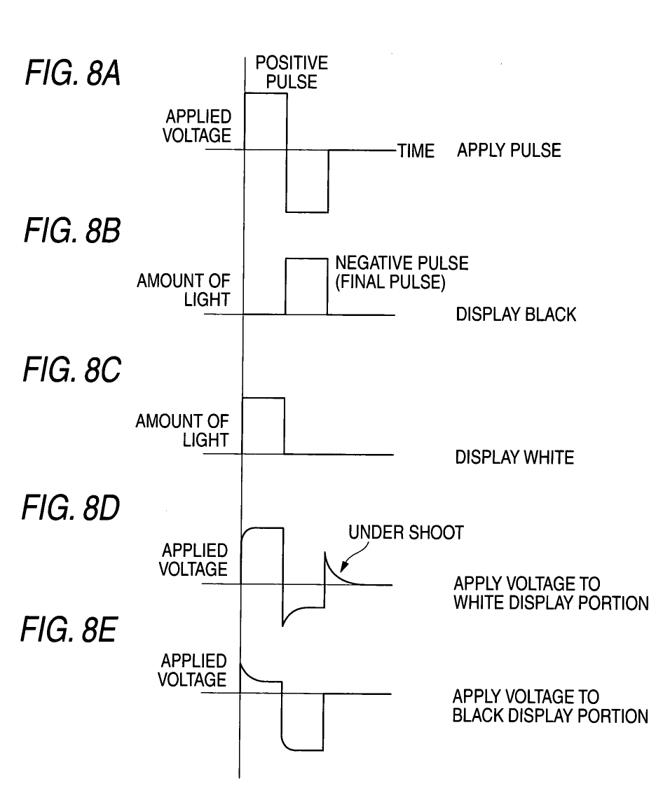

FIG. 8 is a conceptual view showing examples of voltage waveforms applied to the polarity display elements 25 of the second embodiment during irradiation and non-irradiation. The optical switching element 24 is irradiated in conjunction with application of the first positive pulse, and subsequently a region on the optical switching element 24 where black is desired to be displayed is irradiated in conjunction with application of a second negative pulse (i.e., a final pulse). At this time, upon application of the second negative pulse, the electric field is applied to a non-exposure region (a region which is desired to remain white) in the reverse direction (direction for black display). However, at an instant when the applied pulse is turned off, undershoot occurs. Consequently, the second negative pulse is effected as being applied in a forward direction (direction for white display). At this time, when the state of the undershoot portion is changed to a sufficient degree, change of state during the application of the second polarity pulse does not matter. However, when a polarity display element not having a threshold characteristic is adopted, the respective changes of the state are desirably effected to the same degree in terms of energy.

Meanwhile, in the first and second embodiments, measurement of the impedances and observation of response waveform of the polarity display element can be performed as follows. A cell having, e.g., an electrode/a charge generation layer/a charge transport layer/a charge generation layer/an electrode/a substrate, is manufactured as an optical switching element. Another cell having, e.g., a substrate/an electrode/a polarity display element/an electrode/a substrate is manufactured as a polarity display element. Impedance measurement and a response wave of the polarity display element can be ascertained by means of measuring characteristics of the cells. Further, impedance measurement and the response wave can be ascertained by means of connecting the cells in series and observing voltages of the cells. At this time, an ordinary electrode, such as Au, Al, or ITO, can be employed as the electrode. However, when strict measurement is performed, an electrode material involving occurrence of an ohmic contact can be selected. In addition, within a range having no influence on impedance, a protective layer may be inserted for the purpose of protection, such as an electrode/a protective layer/a charge generation layer/a charge transport layer/a charge generation layer/an electrode/substrate. At this time, little problem arises so long as the capacitance of the functional layer, such as the protective layer, is equal to greater than 10 times that of the cell.

### Third Embodiment

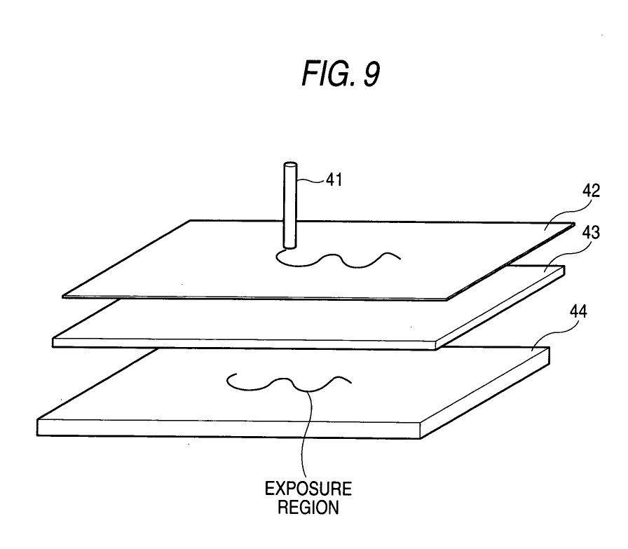

FIG. 9 shows a block diagram of an image display medium of an image display device according to a third embodiment of the present invention. The image display device of the third embodiment has a configuration embodied by further adding an appending device to the image display device of the first or second embodiment. As a result of addition of the appending device, the image display device becomes more effective for a user in terms of usage.

The appending device includes a light generation unit and an appending unit. Specifically, the light generation unit is a light pen 41 capable of radiating light, and the appending unit is a touch panel 42 provided on the image display medium.

The light pen 41 moves so as to trace over the touch panel 42 a letter or picture desired to be written, and radiates light which passes through the display section and is detected by the optical switching element. When the light pen 41 is brought into contact with the touch panel 42, an append start signal is generated, and the signal is transmitted to a control device. A polarity pulse is applied as a voltage to the image display medium on the basis of the append start signal. Appending is performed by the light pen 41 during application of a voltage. Although no particular limitation is imposed on the polarity pulse to be applied, a rectangular pulse is preferable. In the region exposed to the light radiated by the light pen 41, the resistance of the optical switching element 44 is lowered, whereupon the polarity display element 43 is subjected to appending. In an no-light irradiated region, the resistance of the optical switching element 44 remains high and is not subjected to appending. Thereby, appending becomes possible. In this case, the image display medium has a structure where light enters the image display medium by way of the polarity display element 43 and is received by the optical switching element 44. However, there may also be employed a structure where an optical image to be input during ordinary writing operation is input by way of the optical switching element and where an image to be appended is input by way of a display-side element. In this case, the display-side element must permit passage of a predetermined amount of the wavelength of light irradiation used for appending data. The quantity of light of the light pen 41 is controlled by means of receiving a control signal from a control device provided on the image display device, via wired or wireless communication.

A more preferable method is for applying a pulse having a polarity—which displays black during exposure—to an image display medium as an appending method of the light pen 41. Moreover, another preferred method is for applying, at the time of appending, a predetermined voltage to the image display medium displaying an original additional image and radiating only a trail of the additional image as an optical image in accordance with user's append data by means of an input section, thereby displaying the additional image. Since an additional image can be appended without the user viewing operation for writing the image over the entire surface of the image display medium, this method is particularly useful. When the display element has a threshold value, a d.c. bias voltage which is equal to or less than a threshold value can be applied as an applied voltage for appending. However, application of a pulse having the same polarity as that of the second pulse is more desirable. Thereby, additional data can be displayed in an excellent manner on an element having no definite threshold value, as well.

More preferably, when a touch panel is used, additional image data are stored. If there is a mechanism for displaying image data formed by appending additional data to original image data in pursuant to the user's request, a more effective advantage will be yielded.

### Other Embodiments

In addition to the previously-described display methods, a method for inputting a first optical image as an inverted image of a second optical image which enters in conjunction with, application of a second pulse of opposite polarity can be adopted as an image display method. This display method is preferably particularly in a case where writing operation is performed through use of a device which is visible for the user. The reason for this is that, in the case of a device by means of which writing operation is visible for the user and in a case where the device includes operation for momentarily rendering the entire screen black or white during writing operation, the user feels an unnatural sensation during writing operation. In contrast, a method for inputting an inverted image by means of a first image and inputting an optical image by means of a second image does not provide the user with any unnatural sensation and is a very effective display method. Here, the inverted image is an optical image entering the medium, wherein an irradiated region of the image is inverted in contrast with an irradiated region of the second image. Specifically, the first optical image and the second optical image have a relationship of a negative image and a positive image. An example of a device by means of which writing operation is visible for the user includes a device which enables removal of a medium, is viewed by the user at all times or frequently, and is viewed by the user even during a writing operation; e.g., a viewer-type writing device or a second-display-like device. The device by means of which writing operation is not visible for the user is, e.g., a printer, and, more specifically, a device that is not based on a premise that the user views a writing state, such as a laser printer.

The above description is provided while taking a display as a black and white display. However, blue may substitute for black, and yellow or red may substitute for white. As a matter of course, the color of a font used for displaying characters or a background color can be arbitrarily designed by means of respective display elements or a medium.

No limitation is imposed on the type of the driving waveform, and a sinusoidal, rectangular, or triangular waveform is applicable. As a matter of course, a combination of these waveforms or an arbitrary waveform is also applicable. Application of a bias component of some degree is effective for some functional elements; and the driving waveform may be subjected to such application of a bias component.

### EXAMPLES

Examples 1 and 2 correspond to the first embodiment, Examples 3 and 4 correspond to the second embodiment, and Example 5 corresponds to the third embodiment.

### Example 1

In an Example 1, for the purpose of proving the principle of embodiments of the invention, an image display medium (not provided with an optical switching element) 51, which has an electric field migration element—that is, a polarity display element having an insensitive region (i.e., exhibiting a threshold characteristic)—, and an optical switching medium 52 were prepared. The image display medium 51 and the optical switching medium 52 were connected in series, and caused to display by means of controlling voltage application to the display element in accordance with the drive method of the embodiments of the invention, whereby the characteristics were evaluated.

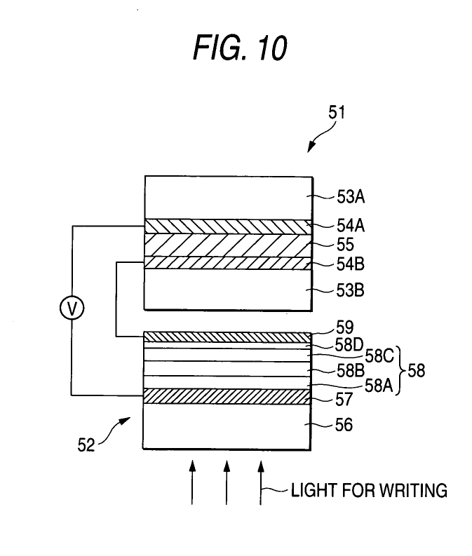

FIG. 10 is a view showing that the image display medium 51 and the optical switching medium 52 are connected in series. The image display medium 51 was prepared as follows.

A glass substrate “7059” (manufactured by Dow Corning) provided with an ITO transparent electrode of 50×50×1.1 mm was used for a display-side substrate 53A and a non-display-side substrate 53B, which constitute the outer faces of the image display medium 51. The inner faces, contacting particles, of the glass substrates were coated with polycarbonate resin (PC-Z) of 5 μm in thickness. A silicone rubber plate measuring 40×40×0.3 mm—whose center was cut out in a square of 15×15 mm so as to form a space—was set on the non-display-side substrate 53B. Spherical fine particles of cross-linked polymethyl methacrylate containing titanium oxide (classified from “Techpolmer-MBX-20-White,” manufactured by Sekisui Fine Chemical) whose mean volume particle size is 20 μm and which contains titania fine powders treated with isopropyl trimethoxy silan in a weight ratio of 100:0.4; and spherical fine particles of cross-linked polymethyl methacrylate containing carbon (classified from “Techpolmer-MBX-20-Black,” manufactured by Sekisui Fine chemical) whose mean volume particle size is 20 μm were mixed in a weight ratio of 2:1. Approximately 15 mg of the mixed particles was sifted and placed through a screen onto the square cut-out space of the silicone rubber plate. Thereafter, the display-side substrate 53A was brought into close contact with the silicone rubber plate, and the substrates 53A and 53B were held in a pressed manner with use of a double clip, whereby the silicone rubber plate and the two substrates 53A and 53B were brought into close contact. Thus, the image display medium 51 having an electric field migration element layer 55 was formed.

When DC voltage of 200 V was applied to an ITO transparent electrode 54A on the display-side substrate 53A, some of the white particles, which had been on the non-display-side substrate 53B side and negatively charged, traveled toward the display-side substrate 53A under the influence of the electric field. At this time, the black particles positively charged traveled toward the non-display-side substrate 53B. Here, even when the voltage was changed to 0 V, particles on the display-side substrate 53A did not travel, and the display density exhibited no change.

Next, when DC voltage of −100 V was applied to the ITO transparent electrode 54A on the display-side substrate 53A, particles did not travel. However, when DC voltage of −200 V was applied to ITO transparent electrode 54A, some of the black particles, which had been on the non-display-side substrate 53B side and positively charged, traveled toward the display-side substrate 53A under the influence of the electric field. At this time, the white particles negatively charged traveled toward the non-display-side substrate 53B. Here, even when the voltage was changed to 0, particles on the display-side substrate 53A did not travel, and the display density exhibited no change.

As a result, the image display medium 51 was confirmed to have an insensitive region in the applied electric field. Furthermore, as a result of study on voltages at which the particles traveled, the threshold value was found to be near 125 V.

Next, the optical switching medium 52 was prepared as follows.

First, in a solution for use in preparation of the charge transport layer, monochlorobenzene was used as the solvent, and a polycarboate resin (manufactured by MITSUBISHI GAS CHEMICAL COMPANY, INC.) was used as the binder. A benzidine-based charge transport material was used, and the loading; i.e., the ratio of the charge transfer material in solid component, was 60 wt %. The solution was prepared such that the concentration of the solution assumes 15%.

In a solution for use in preparation of the upper charge generation layer, titanylophthalocyanine was employed as a charge generation material, and polyvinyl butyral was employed as the binder. The solution was subjected to dispersion processing by means of paint shaking in 1-butanol solution. The solid content of the titanylophthalocyanine was 60 wt %, and that of the polyvinyl butyral was 40 wt %. The concentration of the solvent was adjusted to 4% SC (solid content).

In a solution for use in preparation of the lower charge generation layer, dibromoanthanthrone was employed as a charge generation material, and polyvinyl butyral was employed as the binder. The solution was subjected to dispersion processing by means of paint shaking in 1-butanol solution. The solid content of the titanylophthalocyanine was 60 wt %, and that of the polyvinyl butyral was 40 wt %. The concentration of the solvent was set to 3% SC.

With use of the solutions, the optical switching medium 52 was prepared. An ITO transparent electrode 57 was formed on a polyethylene terephthalate (PET) substrate, whereby a PET substrate 56 was prepared. The PET substrate 56 was coated with the solution for the lower charge generation layer by means of a spin coating method. Thereafter, the coating was dried at 100° C. for one hour, whereby a lower charge generation layer 58A of 0.2 μm thickness was obtained. Next, thereon, the solution for the charge transport layer of 15% SC was applied by means of an applicator method. After the coating, the film was dried at 100° C. for one hour, whereby a charge transport layer 58B of 10 μm thickness was obtained. Next, on the film, an upper charge generation layer 58C of 0.2 μm thickness was formed by means spin-coating the solution for the upper charge generation layer on the film and drying the film at 100° C. for one hour. Thereon, by use of a 3% SC aqueous solution of polyvinyl alcohol (PVA), a film 58D of 0.2 μm thickness was formed by means of the spin coating method. The film was dried at 100° C. for 30 minutes. On the film, an Au thin film 59 of 100 nm thickness was formed by means of a sputtering method.

The image display medium 51 and the optical switching element 52, which had been prepared as described above, were connected in series, whereby evaluation of display characteristics as well as observation of the voltage applied to the display layer were performed. As drive methods, the following driving methods 1 to 4 were employed. Pulses were used in the drive method, and white was displayed by the positive-polarity pulse, and black was displayed by the negative-polarity pulse. Voltage indicated was the applied voltage on the ITO electrode of the optical switching element side on an assumption that the ITO electrode of the display-electrode side was the ground (GND).

[Drive Method 1]

Applied was a drive pulse including a positive-polarity pulse of 280 V_{op′} for an application time of 25 ms serving as a sub-pulse; and subsequently, a negative-polarity pulse of −280 V_{op′} for an application time of 25 ms, and a positive-polarity pulse of 190 V_{op′} for an application time of 25 ms. In conjunction with application of the negative-polarity pulse as the first polarity pulse, the entire surface of the optical switching element was irradiated with light of 500 μW/cm²; and in conjunction with application of the positive-polarity pulse as the sub-pulse and the second polarity pulse, the entire surface was irradiated with light of 500 μW/cm². Next, in conjunction with application of the negative-polarity pulse as the first polarity pulse, the entire surface of the optical switching element was irradiated with light of 500 μW/cm²; and the positive-polarity pulse was applied as the sub-pulse and the second polarity pulse. However, during application of the positive-polarity pulse, the entire surface was not irradiated at all.

[Drive Method 2]

Applied was a drive pulse including a positive-polarity pulse of 500 V_{op′} and an application time of 25 ms, and a negative-polarity pulse of −190 V_{op′} and an application time of 25 ms. In conjunction with application of the positive-polarity pulse as the first polarity pulse, the entire surface was not irradiated at all; and in conjunction with application of the negative-polarity pulse as the second polarity pulse, the entire surface was irradiated with light of 500 μW/cm². Next, in conjunction with application of the positive-polarity pulse as the first polarity pulse, the entire surface was not irradiated at all; and the negative-polarity pulse was applied as the second polarity pulse. However, also during application of the negative-polarity pulse, the entire surface was not irradiated at all.

[Drive Method 3]

Applied was a drive pulse including a negative-polarity pulse of −280 V_{op′} for an application time of 25 ms, and a positive-polarity pulse of 190 V_{op′} for an application time of 25 ms. In conjunction with application the negative-polarity pulse as the first polarity pulse, the entire surface of the optical switching element was irradiated with light of 500 μW/cm²; and in conjunction with application of the positive-polarity pulse as the second polarity pulse, the entire surface was irradiated with light of 500 μW/cm². Next, in conjunction with the negative-polarity pulse as the first polarity pulse, the entire surface of the optical switching element was irradiated with light of 500 μW/cm²; and the positive-polarity pulse was applied as the second polarity pulse. However, during application of the positive-polarity pulse, the entire surface was not irradiated at all.

[Drive Method 4]

Applied was a drive pulse including a negative-polarity pulse of −500 V_{op′} for an application time of 25 ms, and a positive-polarity pulse of 190 V_{op′} for an application time of 25 ms. In conjunction with application the negative-polarity pulse as the first polarity pulse, the entire surface was not irradiated at all; and in conjunction with application of the positive-polarity pulse as the second polarity pulse, the entire surface was irradiated with light of 500 μW/cm². Next, in conjunction with the application the negative-polarity pulse as the first polarity pulse, the entire surface was not irradiated at all; and the positive-polarity pulse was applied as the second polarity pulse. However, also during application of the negative-polarity pulse, the entire surface was not irradiated at all.

### Comparative Example 1>

An electrochromic element was employed as the display element.

A PET substrate having an ITO transparent electrode of 100 μm thickness was used as the substrate. On the electrode, tungstic oxide was deposited so as to form a display layer of 0.1 μm thickness by means of a sputtering method. Thereon, solution—in which LiClO₄ was dissolved in a methanol solution containing 50 wt % poly[oligo(oxyethylene)methacylate] as a supporting electrolyte in a ratio of 0.075 g of LiClO₄ to 1 g of poly[oligo(oxyethylene)methacylate] so that 4 mol % of LiClO₄ is contained per a single mol of oxygen in ether—was applied so as to cover in a thickness of 10 μm (as a polymeric solid electrolyte). Thereon, an Al electrode was formed by means of a sputtering method, whereby an electrochromic display element was obtained.

Test results confirmed that coloration (blue)/decoloration (transparent, but exhibiting white due to reflection on the Al electrode) could be controlled depending on polarity of the applied voltage. Furthermore, by means of changing a time period during which the voltage was applied on the element, tests on the element confirmed that change of coloration/decoloration could be effected at an arbitrary voltage within a range of 1 to 5 V, and that the element had no definite threshold value.

An optical switching element was prepared in the same manner as in Example 1, except that the thickness of the charge transport layer was made 1 μm.

The electrochromic element and the optical switching element, which had been prepared as described above, were connected in series, thereby being subjected to evaluation of display characteristics.

<Evaluation Results of Example 1 and Comparative Example 1>

Example 1 was caused to display in accordance with methods defined in Drive Methods 1 to 4; and display with regard to Comparative Example 1 was performed with applied voltage 1/10 that of the Drive Method 1 and with an application time 100 times that of the Drive Method 1, whereby the characteristics were evaluated. As shown in Table 1, in the display medium of Example 1, values of 3 or higher were obtained in contrast between reflection ratios of irradiation and non-irradiation under application of the second pulse for display of white and black. In contrast, in the electrochromic element of the Comparative Example 1, display under application of the second pulse and during non-irradiation was deteriorated. Accordingly, the contrast value was smaller than or equal to 2.

Here, with regard to evaluation of the contrast between reflection ratios of irradiation and non-irradiation, the larger the value is, the higher the contrast is.

[Table 1]

TABLE 1
Evaluation Results of Example 1 and
Comparative Example 1

| | Drive Method | Contrast |
|---|---|---|
| Example 1 | 1 | >3 |
| | 2 | >3 |
| | 3 | >3 |
| | 4 | >3 |
| Comparative | | <2 |
| Example 1 | | |

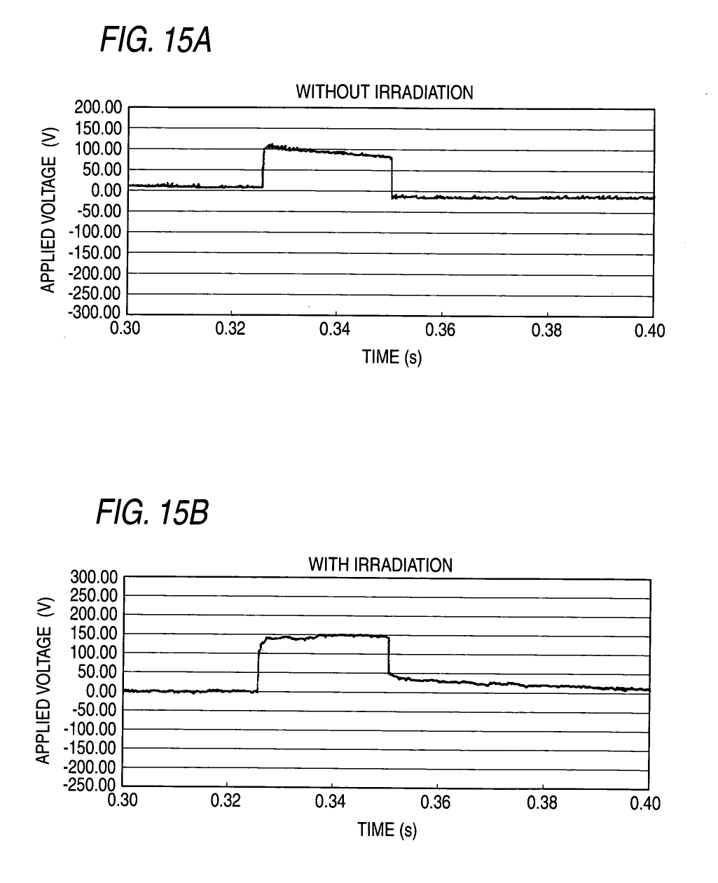

Voltage applied to the display element during application of the second pulse in Drive Method 1 was measured, whereby waveform response was examined. The results are shown in FIGS. 15A and 15B. As shown in drawings, the results reveals that a voltage above 125 V was applied on the display element during irradiation and that a voltage below 125 V was applied on the display element during non-irradiation. Accordingly, the results confirmed that voltage control upon light irradiation had been achieved at precedent and subsequent to the threshold value.

### Example 2

In Example 2, an image display medium 61 including an electric field migration element—which was a polarity display element having an insensitive region (i.e., having a threshold characteristic)—was prepared. The image display medium 61 was caused to display by means of controlling voltage application to the display element in accordance with the drive method of embodiments of the invention, whereby the characteristics were evaluated.

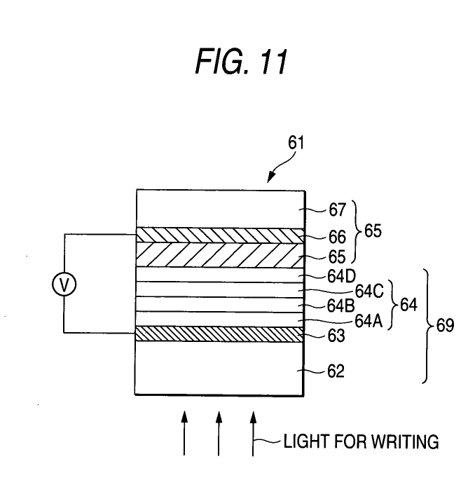

FIG. 11 is a view showing the image display medium 61.

First, a display-element-side substrate 68 was fabricated, and subsequently an optical-switching element-side substrate 69 was fabricated. The display-element-side substrate 68 and the optical-switching-element-side substrate 69 were laminated, whereby the image display medium 61 to be described below was prepared.

The display-element-side substrate 68 was prepared as follows.

A glass substrate “7059” (manufactured by Dow Corning Co., Ltd.) provided with an ITO transparent electrode measuring 50×50×1.1 mm was used for a display-side substrate 67 constituting the outer faces of the image display medium 61. The inner faces contacting particles of the glass substrates were coated with polycarbonate resin (PC-Z) to a thickness of 5 μm. A silicone rubber plate measuring 40×40×0.3 mm—whose center was cut into a square of 15×15 mm so as to form a space—was set on the display-side substrate 67. Spherical fine particles of cross-linked polymethyl methacrylate containing titanium oxide (classified as “Techpolmer-MBX-20-White,” manufactured by Sekisui Fine Chemical) whose mean volume particle size is 20 μm and which contains titania fine powders treated with isopropyl trimethoxy silan in a weight ratio of 100:0.4; and spherical fine particles of cross-linked polymethyl methacrylate containing carbon (classified from “Techpolter-MBX-20-Black,” manufactured by Sekisui Fine Chemical) whose mean volume particle size is 20 μm were mixed in a weight ratio of 2:1. Thereafter, approximately 15 mg of the mixed particles was sifted and placed through a screen onto the square cut-out space of the silicone rubber plate.

Next, the optical switching element-side substrate 69 was prepared as follows.

First, in the same manner as in the Example 1, a solution for preparation of a charge transport layer, that for preparation of an upper charge generation layer, and that for preparation of a lower charge generation layer were prepared. An ITO transparent electrode 63 was formed on a PET substrate 62, whereby a PET substrate 62 was prepared. The PET substrate 62 was coated with the solution for the lower charge generation layer by means of a spin coating method. Thereafter, the coating was dried at 100° C. for one hour, whereby a lower charge generation layer 64A of 0.2 μm thickness was obtained. Next, thereon, the solution for the charge transport layer of 15% SC was applied by means of an applicator method. After the coating, the film was dried at 100° C. for one hour, whereby a charge transport layer 64B of 10 μm thickness was obtained. Next, on the film, the solution for the upper charge generation layer was applied, whereby an upper charge generation layer 64C of 0.2 μm thickness was formed. Thereafter, the film was dried at 100° C. for one hour. Thereon, an aqueous solution of polyvinyl alcohol in which titanium oxide had been dispersed was applied by means of a spin coating method, and dried. Thus, a PVA film 64D serving as a white reflection film was formed.

The thus-prepared display-element-side substrate 68 and the optical-switching-element-side 69 substrate were brought into close contact, and the space between the substrates was sealed, thereby completing preparation of the image display medium 61.

By use of the thus-prepared image display medium 61, display characteristics were evaluated. As a drive method, the following driving method 5 was employed.

<Drive Method 5>

Applied was a drive pulse including a positive-polarity pulse of 700 V_{op′} for an application time of 25 ms, and a negative-polarity pulse of −500 V_{op′} for an application time of 25 ms. In conjunction with application of the positive-polarity pulse as the first polarity pulse, the entire surface of the optical switching element was irradiated with light of 500 μW/cm²; and in conjunction with application of the negative-polarity pulse as the second polarity pulse, the black display region (a region where black is desired to be displayed) was irradiated with light, and the other region (a region which is desired to remain white) was not irradiated.

### Comparative Example 2

An electrochromic display element was employed as the display medium.

A PET substrate having an ITO transparent electrode of 100 μm thickness was used as the substrate. On the electrode, tungstic oxide was deposited so as to form a display layer of 0.1 μm thickness by means of a sputtering method. Thereon, a solution—in which LiClO₄ was dissolved in a methanol solution, which contains 50 wt % of poly[oligo(oxyethylene)methacylate] as a supporting electrolyte in a ratio of 0.075 g of LiClO₄ to 1 g of poly[oligo(oxyethylene)methacylate] so that 4 mol % of LiClO₄ is contained per a single mol of oxygen in ether—was applied so as to cover to a thickness of 10 μm (as a polymeric solid electrolyte). Accordingly, an electrochromic display-element-side substrate was obtained.

An optical-switching-element-side substrate was prepared in the same manner as in the Example 2, except that the thickness of the charge transport layer was made to be 1 μm.

An image display medium was prepared by means of laminating the thus-prepared display-element-side substrate and the optical-switching-element-side substrate.

By use of the thus-prepared image display medium, display characteristics were evaluated. As a drive method, Drive Method 6 described hereinbelow was employed.

[Drive Method 6]

Applied was a drive pulse including a positive-polarity pulse of 7 V_{op′} for an application time of 5 s as the first pulse, and a negative-polarity pulse of −5 V_{op′} for an application time of 5 s. In conjunction with application the first polarity pulse, the entire surface of the optical switching element was irradiated with light of 500 μW/cm²; and in conjunction with the application of the second polarity pulse, a predetermined region was light-irradiated with light of 500 μW/cm², and the other region was not irradiated.

<Evaluation Results of Example 2 and Comparative Example 2>

Upon comparison of the thus-displayed images, a contrast value of 3 or higher was obtained between the black-display region and the white-display region in Example 2; however, in Comparative Example 2, a contrast value smaller than or equal to 2 was obtained.

### Example 3

In order to verify the principle of embodiments of the invention, an image display medium (not having an optical switching element) 71 equipped with an electrophoresis element serving as the polarity display element and an optical switching medium 72 were fabricated respectively in Example 3. With using a driving method, irrelevant to a threshold value, for preventing deterioration of the irradiated region, which would otherwise be caused at the time of application of the second pulse, a display in which the image display medium 71 and the optical switching medium 72 were connected in series was evaluated.

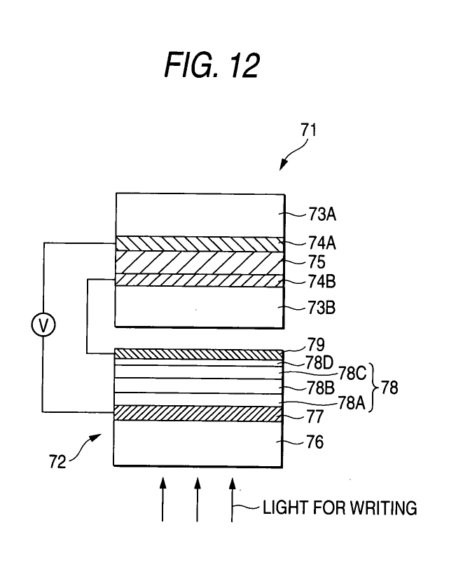

FIG. 12 is a view showing a state in which the image display medium 71 and the optical switching medium 72 are connected in series. The image display medium 71 was fabricated as follows.

Butyl methacrylate, methyl methacrylate, and an acrylic acid were copolymerized, to thus prepare acrylic resin. Dipentaerythrytol, hexaacrylate, and a photopolymerization initiator were added as photosensitive monomers to the acrylic resin, to thus prepare a photoresist material.

Next, a dispersed solution prepared as a result of polymer particles colored with a black pigment and surface-treated titanium oxides having a particle size of 3 μm having been dispersed in tetrachloroethylene was encapsulated in a microcapsule formed from gelatin and gum arabic through use of complex coacervation.

The microcapsule and the photoresist material were mixed, and the resultant mixture was coated over a transparent glass plate 73A formed from an A4-size substrate having an ITO transparent electrode 74A formed thereon, by means of an applicator. The coating was then dried, whereby a microcapsule layer (an electrophoresis element layer) 75 having a thickness of 60 μl was obtained. The transparent glass substrate 73B, the ITO transparent electrode 74B being formed over the entirety thereof, was bonded to the microcapsule layer 75 by means of cladding.

In order to control impedance of the thus-prepared image display medium 71, capacitance and resistance components of the image display medium 71 were measured. The results of measurement showed a capacitance of 0.1 nF/cm² and a resistance of 80 MΩ/cm². The time constant of the electrophoresis element was 8 msec.

The optical switching medium 72 was fabricated in the same manner as in Example 1. The capacitance and resistance of the optical switching medium 72 were measured during a non-exposure period. The results of measurement show a capacitance of 50 pF/cm² and a resistance of 2 GΩ/cm². The time constant of the optical switching element was 100 msec.

The display medium 71 and the optical switching medium 72, which were fabricated as mentioned above, were connected in series, and a voltage was applied thereto. Further, the image display medium and the optical switching medium were exposed to light irradiation or no-light irradiation, to thus evaluate a display characteristic of the mediums. Drive method 7, which will be provided below, was employed as a drive method.

[Drive Method 7]

Applied was a drive pulse including a first positive-polarity pulse of 100 V_{Op} for 100 ins and subsequently a second negative-polarity pulse of −50V_{Op} for 100 ms. A time interval between pulses was set to two seconds. According to the drive method, white was displayed by the positive-polarity pulse, and black was displayed by the negative-polarity pulse. In conjunction with the positive-polarity pulse applied as the first polarity pulse, the entirety of the optical switching element was irradiated with light of 500 μW/cm². Further, in conjunction with a negative-polarity pulse applied as a second polarity pulse, the entirety of the optical switching element was exposed to light. Next, in conjunction with a positive-polarity pulse applied as the first polarity pulse, the entirety of the optical switching element was exposed to light of 500 μW/cm². Further, in conjunction with a negative-polarity pulse applied as the second polarity pulse, however, the optical switching element was not exposed to light at all during application of the negative-polarity pulse.

<Evaluation Results of Example 3>

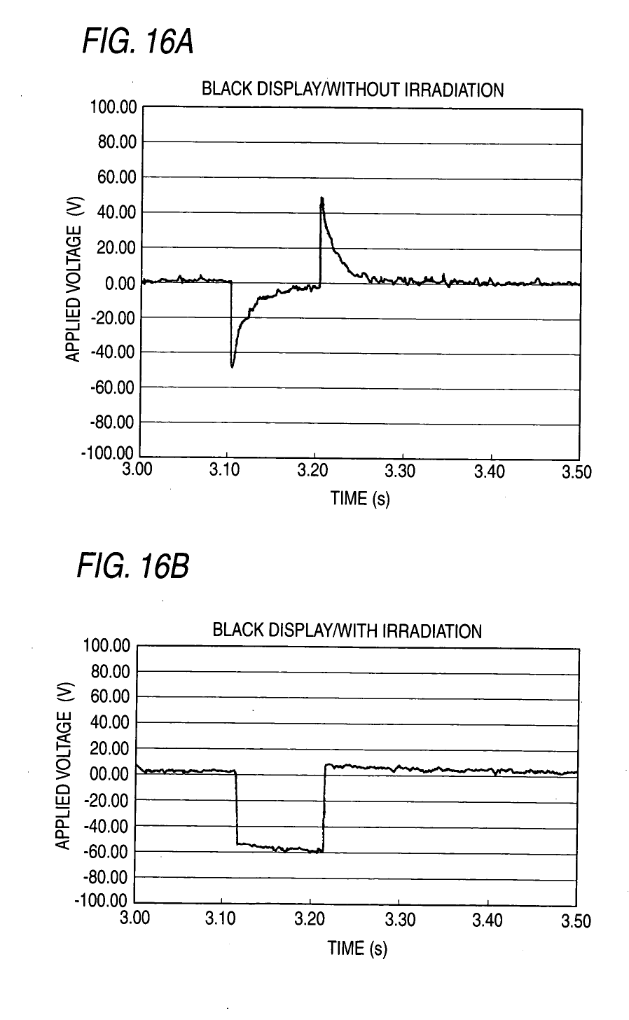

FIGS. 16A and 16B show response waveforms. The pulse, which was not radiated during application of the negative-polarity pulse, was undershot. The ratio of power of the positive-polarity pulse to that of the negative-polarity pulse; that is, a ratio of an area produced by multiplying voltage by time, is essentially 1:1. Under this condition, the reflectivity achieved when the image display medium was exposed to light during application of the negative-polarity pulse was compared with the reflectivity achieved when the image display medium was not exposed during application of the negative-polarity pulse, whereby a contrast of three or more was obtained.

### Example 4

An image display medium 81 having an electrophoresis serving as the polarity display element, was manufactured in Example 4. A display was provided by means of controlling the voltage applied to the display element according to the drive method for inhibiting deterioration of an image, which would otherwise arise in the region which is not exposed during application of the second pulse, whereby characteristics of the image display medium were evaluated.

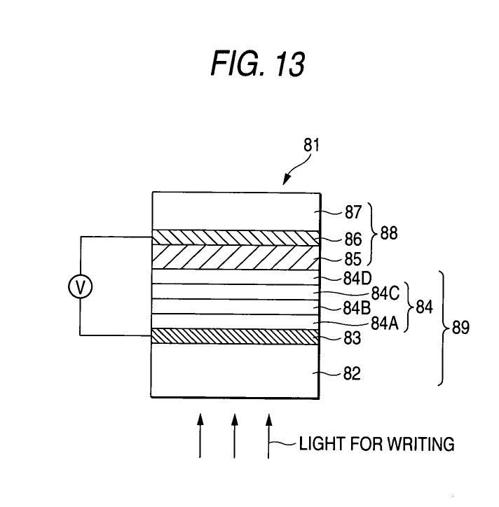

FIG. 13 is a view showing the image display medium 81.

As will be described below, after manufacture of a display element substrate 88, an optical switching element substrate 89 was formed, and the display element substrate 88 and the optical switching element substrate 89 were bonded together, to thus form the image display medium of the present invention.

The display element substrate 88 was manufactured in the same manner as in Example 3, except that the transparent glass substrate having the ITO transparent element formed thereon is not finally bonded to the display element substrate.

The optical switching element substrate 89 was manufactured in the same manner as in Example 3, except that an electrode is finally formed from Au.

The thus-formed two substrates 88, 89 were bonded together by means of a laminate, to thus form the image display medium 81 having the electrophoresis layer 85.

Display characteristics of the image display medium were evaluated through use of the image display medium 81. Drive method 8 to be described below was used as a drive method.

[Drive Method 8]

Applied was a drive pulse including a first positive-polarity pulse of 100 V_{Op} for 100 ms as a drive pulse and subsequently a second negative-polarity pulse of −50V_{Op} for 100 ms. A time interval between pulses was set to two seconds. According to the drive method, white was displayed by the positive-polarity pulse, and black was displayed by the negative-polarity pulse. In conjunction with the positive-polarity pulse was applied as the first polarity pulse, the entirety of the optical switching element was exposed to light of 500 μW/cm². Further, in conjunction with a negative-polarity pulse applied as a second polarity pulse, a black display region (a region desired to be displayed in black) was exposed to light of 500 μW/cm², and the remaining regions (regions desired to be left white) were not exposed.

<Evaluation Result of Example 4>

Contrast of 3 or more was obtained between the black display region and the white display region under this requirement.

### Example 5

In Example 5, an image display was evaluated through use of a viewer-type writing device, and an image display medium and a drive method of embodiments of the invention.

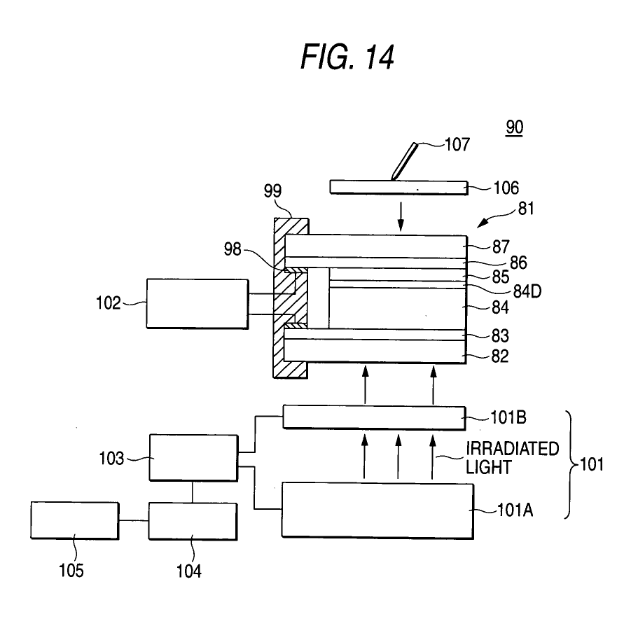

FIG. 14 is a view showing an image display device 90.

The image display device 90 was fabricated from the image display medium 81 formed in Example 4.

The device 90 had a configuration such as that shown in FIG. 14, and the image display medium 81 could be disconnected from the writing device. The device 90 had an optical image writing device 101, which had a feeding terminal 98 connected to the image display medium 81 and effected radiation/nonradiation of image data; a voltage application device 102 for applying a write voltage at the time of radiation/nonradiation of image data; a control device 103 for controlling the optical image writing device 101 and the voltage application device 102; an image storage device 104 for storing data, such as image data; an input/output device 105 for acquiring data from the outside; and a touch panel 106 for enabling the user to perform appending operation. The image display medium 81 is sandwiched between the touch panel 106 and the image writing means 101.

Image display and appending operations were performed through use of this device. Input operation was commenced through use of a pen by way of the touch panel 106, and appending image data were caused to enter the medium 81 in an appending mode. Moreover, in order to reliably display the appended region after completion of appending operation, the device is also provided with an image regeneration mechanism for redisplaying image data formed by adding append data to the original display.

Display characteristics of the image display medium were evaluated through use of the image display device 90. Drive Method 9 provided below was used as the drive method.

[Drive Method 9]

Applied was a drive pulse including a first positive-polarity pulse of 150 V_{Op} for 100 ms as a drive pulse, and a second negative-polarity pulse of −100V_{Op} for 100 ms. An inverted image of the image applied in the form of the second pulse was optically input as the first pulse.

<Evaluation Result of Example 5>

The irradiated region turned white as a result of input of the first pulse. Next, the irradiated region was displayed black by the second pulse. At this time, deterioration of the white region was hardly observed.

Next, appending was performed. When the pen 107 came into contact with the touch panel 106, the mode was switched to an image input mode. In connection with an optical image to be input, only the data portion based on the information input by the pen turned into an exposed portion, and the remaining data portions turned into no-light irradiated regions. At this time, a pulse of −100 Vₒₚ was input to the image display medium 81 for a period of 50 ms. As a result, the append data could be discerned to be displayed as an image. Moreover, it was ascertained that the original image and the image appended thereto could be displayed more excellently by displaying the images through use of the image regeneration display mechanism.

1. A photo-write-type image display method for photo-writing into an image display medium comprising a polarity display element and an optical switching element, the method comprising:
applying a first polarity pulse to the image display medium to write a first display color into the image display medium; and
applying a second polarity pulse to the image display medium while exposing the optical switching element to light, to write a second display color to the image display medium, wherein:
in the applying of the second polarity pulse, voltage is applied to the polarity display element so that the first display color displayed in a non-exposure region of the image display medium is maintained after the applying of the second polarity pulse.

2. The method according to claim 1, wherein in the applying of the first polarity pulse, the first polarity pulse is applied to the image display medium while the optical switching element is exposed to light.

3. The method according to claim 1, wherein in the applying of the first polarity pulse, the first polarity pulse is applied to the image display medium while the optical switching element is not exposed to light.

4. The method according to claim 1, wherein:
the polarity display element has an insensitive region; and
in the applying of the second polarity pulse, voltage of the second polarity pulse and an amount of the exposed light are adjusted so that an effective value of voltage applied to an area of the polarity display element corresponding to an exposure region is equal to or greater than a threshold value of the polarity display element having the insensitive region and that an effective value of voltage applied to another area of the polarity display element corresponding to the non-exposure region is equal to or less than the threshold value.

5. The method according to claim 4, wherein the polarity display element having the insensitive region includes one of an electric field migration element and an electric field rotary element.

6. The method according to claim 1, wherein in the applying of the second polarity pulse, voltage of second polarity pulse and an amount of the exposed light are adjusted so that voltage applied to an area of the polarity display element corresponding to the non-exposure region is undershot when application of the voltage is turned off.

7. The method according to claim 6, wherein the polarity display element includes one selected from the group consisting of an electric field migration element, an electric field rotary element, an electrophoresis element, an electron granular material, and an electroluminescence element.

8. The method according to claim 6, wherein when the switching element is not exposed to the light, a resistive component of the switching element is larger than that of the polarity display element and a time constant of the optical switching element is equal to or more than five times that of the polarity display element.

9. The method according to claim 2, wherein the first display color is written into the image display medium by exposing the entire surface of the image display medium to the light.

10. The method according to claim 3, wherein the first display color is written into the image display medium by not-exposing the entire surface of the image display medium to the light.

11. The method according to claim 1, wherein the optical switching element includes a charge transport layer and charge generation layers that sandwich the charge transport layer therebetween.

12. The method according to claim 1, wherein effective voltage of the first polarity pulse is larger than that of the second polarity pulse.

13. The method according to claim 1, further comprising:
appending to the image display medium, wherein:
the appending generates an append start signal by bringing a light generation device that generates light irradiated onto the optical switching element into contact with an appending device provided on a surface of the image display medium, and appends by using the light generation device while a third polarity pulse is applied to the image display medium based on the append start signal.

14. The method according to claim 13, wherein:
the appending device includes a touch panel; and
the light generation device includes a light pen.

15. The method according to claim 14, wherein the third polarity pulse is a polarity pulse for black display.

16. The method according to claim 13, wherein the third polarity pulse is a rectangular pulse.

17. A photo-write-type image display device comprising:
an image display medium including:
a polarity display element having an insensitive region;
an optical switching element;
a pair of electrodes at least one of which has a light transmission characteristic; and
a pair of substrates at least one of which located on the same side as the electrode having the light transmission characteristic has a light transmission characteristic;
a voltage application device that applies a first polarity pulse and a second polarity pulse as voltages to the image display medium;
a writing device that applies the voltage by the voltage application device while radiates image information onto the optical switching element by means of light irradiation; and
a control device that controls the voltage application device and the writing device, wherein:
the control device performs a control operation after application of the first polarity pulse and at a time of application of the second polarity pulse so that an effective value of voltage applied to an area of the polarity display element corresponding to an exposure region of the optical switching element is equal to or greater than a threshold value of the polarity display element having the insensitive region and that an effective value of voltage applied to an area of the polarity display element corresponding to a non-exposure region of the optical switching element is equal to or less than the threshold value.

18. A photo-write-type image display device comprising:
an image display medium including:
a polarity display element;
an optical switching element;
a pair of electrodes at least one of which has a light transmission characteristic; and
a pair of substrates at least one of which located on the same side as the electrode having the light transmission characteristic has a light transmission characteristic;
a voltage application device that applies a first polarity pulse and a second polarity pulse as voltages to the image display medium;
a writing device that applies the voltage by the voltage application device while radiates image information onto the optical switching element by means of light irradiation; and
a control device that controls the voltage application device and the writing device, wherein:
the control device performs control operation so that voltage applied to an area of the polarity display element corresponding to a non-exposure region of the optical switching element is undershot when application of the second polarity pulse application is turned off, to perform impedance-matching control operation with respect to the polarity display element and the optical switching element after application of the first polarity pulse and at a time of application of the second polarity pulse.
